(19) United States
(12) Patent Application Publication
(10) Pub. No.: US 2026/0065258 A1
(43) Pub. Date: Mar. 5, 2026

(54) FINANCIAL TRANSACTION SYSTEM AND METHOD

(71) Applicant: DIEBOLD NIXDORF, INCORPORATED, North Canton, OH (US)

(72) Inventors: David Ober, Statesville, NC (US); Jeff Bender, Colleyville, TX (US)

(21) Appl. No.: 19/383,855

(22) Filed: Nov. 10, 2025

Related U.S. Application Data
(63) Continuation of application No. 18/028,652, now abandoned.
(60) Provisional application No. 63/092,054, filed on Oct. 15, 2020.

(51) Int. Cl. G06Q 20/32; G06Q 20/10; G06Q 20/20; G06Q 20/40

(52) U.S. Cl. CPC G06Q 20/3223; G06Q 20/1085; G06Q 20/202; G06Q 20/4014; G06Q 20/4015; G06Q 20/4012

(57) ABSTRACT

A financial transaction method can include creating a token correlated to a financial account. The method can also include storing the correlation between the token and the financial account in a token database. The method can also include transmitting the token to a mobile computing device operating an application. The method can also include displaying the token on a display of the mobile computing device. The method can also include receiving, over a public network, the token and data associated with a first financial transaction. The method can also include confirming identity between the token transmitted to the mobile computing device and the token received from the secondary computing device. The method can also include transmitting over the public network, approval of the first financial transaction to the secondary computing device in response to the confirming.

### CROSS-REFERENCE TO RELATED APPLICATIONS

This application is a National Phase filing of International Application Ser. No. PCT/US21/55171, for a FINANCIAL TRANSACTION SYSTEM AND METHOD, filed Oct. 15, 2021, which claimed the benefit of U.S. Provisional Patent Application Ser. No. 63/092,054 for a FINANCIAL TRANSACTION SYSTEM AND METHOD, filed on Oct. 15, 2020, which is hereby incorporated by reference in its entirety.

### BACKGROUND

### 1. Field

The present disclosure relates to financial transaction computing systems.

### 2. Description of Related Prior Art

Banking transactions requested by a customer may be processed in different ways. For example, a banking customer may visit a teller and the teller may process the banking transaction. Alternatively, the customer may use an automated transaction machine (ATM) to process a banking transaction.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A financial transaction method can include creating, with a first server operating a token database, a token correlated to a financial account. The method can also include storing, with the first server, the correlation between the token and the financial account in the token database. The method can also include transmitting, with the first server, the token to a mobile computing device operating an application at least partially controlled by the first server. The method can also include displaying the token on a display of the mobile computing device with the application operating on the mobile computing device. The method can also include receiving, at the first server, over a public network, the token and data associated with a first financial transaction from a secondary computing device after the transmitting. The method can also include confirming, with the first server, identity between the token transmitted to the mobile computing device and the token received from the secondary computing device. The method can also include transmitting, with the first server, over the public network, approval of the first financial transaction to the secondary computing device in response to the confirming.

According to other features, receiving the token can be further defined as receiving, at the first server, over the public network, the token and data associated with the first financial transaction from the secondary computing device after the transmitting, wherein the secondary computing device is an automated transaction machine (ATM). The receiving the token can be alternatively further defined as receiving, at the first server, over the public network, the token and data associated with the first financial transaction from the secondary computing device after the transmitting, wherein the secondary computing device is a point of sale (POS) device.

In other features, the method can also include determining, with the first server, an identification of a merchant at which the mobile computing device is located prior to creating the token. The creating of the token can be further defined as creating, with the first server operating the token database, the token correlated to the financial account and correlated to the identification of the merchant. The receiving of the token can be further defined as receiving, at the first server, over the public network, the token and the data associated with the first financial transaction and the identification of the merchant from the secondary computing device after the transmitting. The confirming of identity can be further defined as confirming, with the first server, identity between the token transmitted to the mobile computing device and the token received from the secondary computing device and also identity between the identification of the merchant determined during the determining and the identification of the merchant received during the receiving.

According to additional features, the determining of the identification can include receiving, with the first server, a global position of the mobile computing device operating the application substantially concurrently with receiving the token and data associated with the first financial transaction from the secondary computing device. The determining of the identification can also include accessing, with the first server, a database storing correlations between global positions and identifications of a merchants. The determining of the identification can also include transmitting, with the application operating on the mobile computing device, the global position of the mobile computing device to the first server.

According to other features, the determining of the identification can include receiving, with the first server, a global position of the mobile computing device operating the application before receiving the token and data associated with the first financial transaction from the secondary computing device. The determining of the identification can also include accessing, with the first server, a database storing correlations between global positions and identifications of a merchants before receiving the token and data associated with the first financial transaction from the secondary computing device.

In other features, the determining of the identification can include receiving, with the first server, a global position of the mobile computing device operating the application before receiving the token and data associated with the first financial transaction from the secondary computing device. The determining of the identification can also include accessing, with the first server, a database storing correlations between global positions and identifications of a merchants before receiving the token and data associated with the first financial transaction from the secondary computing device.

According to additional features, the determining of the identification can also include receiving, with the first server, the identification of the merchant from the application operating on the mobile computing device before receiving the token and data associated with the first financial transaction from the secondary computing device. The method can also include controlling, with the application operating on the mobile computing device, a display of the mobile computing device to display indicia corresponding to one or more identifications of merchants, wherein the identification of the merchant is received with the identification of the merchant with the first server and is one of the identifications displayed during the controlling.

According to other features, the method can also include positioning an automated transaction machine (ATM) in a building at a first location, wherein the ATM includes a recycler and one or more cassettes configured to hold currency and wherein the ATM lacks a display and a card reader. The method can also include placing the ATM in communication with the first server. The method can also include positioning the first server at a second location that is physically remote from the building at the first location. The method can also include receiving, at the first server, a first input from a tertiary computing device that is positioned in the building at the first location with the ATM. The tertiary computing device is physically distinct from the ATM. The first input can define details of a second financial transaction. The method can also include transmitting, with the first server, a first output to one of the ATM and the tertiary computing device that includes approval of the second financial transaction. The method can also include receiving, at the ATM, a command to dispense currency from one of the first server and the tertiary computing device. The method can also include dispensing, with the recycler of the ATM, a quantity of currency in response to receiving the first output.

In other features, the transmitting of the first output can be further defined as transmitting, with the first server, the first output to the tertiary computing device wherein the first output includes approval of the second financial transaction. The receiving of the command can be further defined as receiving, at the ATM, the command to dispense currency from the tertiary computing device.

According to additional features, the transmitting of the first output can be further defined as transmitting, with the first server, the first output to both of the ATM and the tertiary computing device. The first output can include approval of the second financial transaction. The receiving of the command can be further defined as receiving, at the ATM, the command to dispense currency from the first server.

According to other features, the method can also include generating the first input with a tablet computer configured to transmit commands to the ATM. The tablet computer can define the tertiary computing device. The method can also include generating the first input with the application operating on the mobile computing device. The mobile computing device can define the tertiary computing device. The method can also include generating the first input with a desktop computing device configured to transmit commands to the ATM. The desktop computing device can thus define the tertiary computing device.

In other features, the method can also include transmitting commands to the ATM from the tertiary computing device to intake at least one note of currency at the ATM. The method can also include transmitting a command to the ATM from the tertiary computing device to intake a check. The ATM then executes the command. The method can also include transmitting a command to the ATM from the tertiary computing device to intake a check and to dispense at least one note of currency, which is executed by the ATM.

A financial transaction system can include a first server defining a financial core and maintaining a ledger of a plurality of financial accounts and transactions associated with the plurality of accounts. The financial transaction system can also include a second server defining a branch server and disposed in communication with the first server over a first network. The second server can be positioned in a building at a first location while the first server is positioned at a second location that is physically remote from the building at the first location. The financial transaction system can also include a first automated transaction machine (ATM) positioned at the building at the first location. The first ATM can have a recycler, at least one cassette configured to hold currency, a display, a card reader, and an electronic pin pad (EPP). The first ATM can be in communication with the first server over a financial switch network. The financial transaction system can also include a second ATM positioned in the building at the first location. The second ATM can include a recycler and at least one cassette configured to hold currency. The second ATM can lack a display and a card reader. The second ATM can be in communication with the second server over a local secure network. The financial transaction system can also include a tablet computing device having one or more processors and moveably located in the building at the first location. The tablet computing device can be in communication with the second server over the local secure network and configured to communicate directly with the second ATM. The financial transaction system can also include a desktop computing device fixedly located in the building at the first location. The desktop computing device can be in communication with the second server over the local secure network. The financial transaction system can also include at least one peripheral in communication with the second server over the local secure network, the at least one peripheral selected from the group consisting of a printer, an electronic signature pad, and a card reader.

### BRIEF DESCRIPTION OF THE DRAWINGS

The detailed description set forth below references the following drawings:

FIG. 1 is a schematic view of a portion of a financial transaction system according to an exemplary embodiment of the present disclosure;

FIG. 2 is a functional block diagram of an exemplary ATM according to one or more implementations of the present disclosure;

FIG. 3 is a schematic view of another portion of the exemplary financial transaction system; and

FIG. 4 is a simplified flow diagram of a process that can be performed by one or more embodiments of the present disclosure.

### DETAILED DESCRIPTION

The present disclosure, as demonstrated by the exemplary embodiment described below, can provide a customer-centric design that enhances cash efficiency. As used herein, “cash efficiency” generally refers reducing the frequency of cash deliveries to bank branches and cash transfers from bank branches. This can also allow cash vaults to be downsized and reduce the number of counters and teller drawers at a branch. These are objective benefits. Further, the system disclosed herein provides non-objective benefits in that a bank customer is engaged rather than serviced. The customer can be intercepted before getting into a teller line by an in-lobby teller carrying a tablet computer. Through the tablet computer, the teller assists the customer, for example by controlling a dispensing device to dispense cash. The tablet computer can transmit a command to the dispensing device and the command is executed by the dispensing device. As the device is dispensing, the customer and the teller can have a friendly conversation. The system also provides benefits in purchasing transactions.

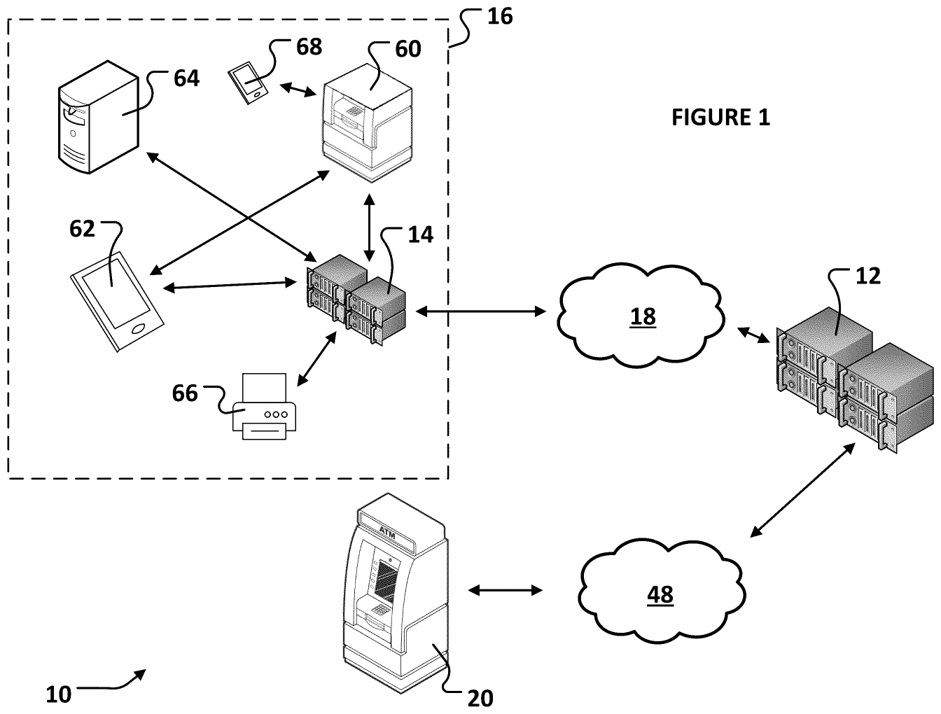

The components of an exemplary system according to one or more embodiments are shown in FIG. 1. An exemplary financial transaction system 10 includes a first server 12. The exemplary first server 12 defines a core of a banking system. The exemplary first server 12 maintains a ledger of a plurality of financial accounts and transactions associated with these accounts. The exemplary first server 12 includes one or more processors and is configured to apply business logic to requested financial transactions. It should be appreciated that the term “processor” as used herein can refer to both a single processor and two or more processors operating in a parallel or distributed architecture. The processor(s) of the first server 12 can be configured to perform general functions including, but not limited to, loading/executing an operating system of the first server 12, controlling communications to and from the first server 12, and controlling read/write operations at the memory of the first server 12.

The exemplary financial transaction system 10 also includes a second server 14. The exemplary second server 14 is positioned at a branch of the bank and the exemplary second server 14 thus defines a branch server. The exemplary second server 14 includes one or more processors. The box in dash-line referenced at 16 represents the branch, which is physically remote from the exemplary first server 12. The exemplary branch 16 is a building at a first location while the exemplary first server 12 is positioned at a second location that is physically remote from the building 16 at the first location. The exemplary second server 14 is disposed in communication with the exemplary first server 12 over a first network 18. The exemplary second server 14 can transmit transaction requests to the exemplary first server 12 over the exemplary first network. The exemplary second server 14 can receive approvals or denials of transaction requests from the exemplary first server 12 over the exemplary first network 18. The exemplary first network 18 can be a private network or virtual private network, or can be defined by a financial switch network used by a plurality of banks.

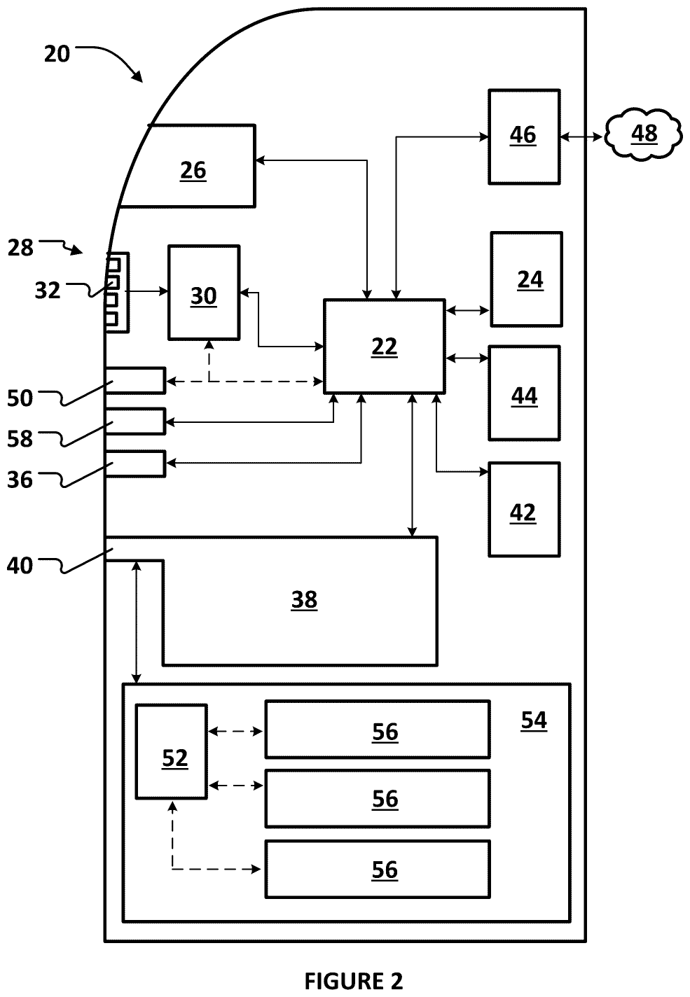

The exemplary financial transaction system 10 also includes a first automated transaction machine (ATM) 20 positioned at the building 16 at the first location. The exemplary ATM 20 is shown as outside of the branch 16, but could be positioned inside the branch 16 or inside a lobby of the branch 16. FIG. 2 discloses a functional block diagram of an exemplary ATM 20 according to one or more implementations of the present disclosure. The ATM 20 includes different structures and subsystems for receiving input from a user and executing transactions. The ATM 20 includes a computing device 22. The exemplary computing device 22 has one or more processors and a non-transitory, computer readable medium. The computing device 22 operates under the control of an operating system, kernel and/or firmware and executes or otherwise relies upon various computer software applications, components, programs, objects, modules, data structures, etc. The exemplary computing device 22 can operate under the control of the Windows® operating system. The computer readable medium (memory) of the computing device 22 can include random access memory (RAM) devices comprising the main storage of computing device 22, as well as any supplemental levels of memory, e.g., cache memories, non-volatile or backup memories (e.g., programmable or flash memories), read-only memories, etc. In addition, the memory may be considered to include memory storage physically located elsewhere from RAM in the computing device 22, such as any cache memory in a processor, as well as any storage capacity used as a virtual memory. The computing device 22 can also include one or more mass storage devices, e.g., a floppy or other removable disk drive, a hard disk drive, a direct access storage device (DASD), an optical drive (e.g., a CD drive, a DVD drive, etc.), and/or a tape drive, among others, represented by memory 24.

The exemplary ATM 20 also includes a display 26. The exemplary computing device 22 can control the display 26 to present information to the user for furthering completion of the transaction. The display 26 can be a touch screen that allows the user to enter information through the display 26. The exemplary display 26 is configured to transmit any user-entered information to the exemplary computing device 22.

The exemplary ATM 20 also includes a key pad 28 and an encryption module 30. Generally, the combination of a key pad and an encryption module are referred to in the art as an encrypted pin pad (EPP). The exemplary key pad 28 includes a plurality of keys, such as key 32. The exemplary encryption module 30 has one or more processors and a non-transitory, computer readable medium. The user can press the keys of the key pad 28 to enter a Personal Identification Number (PIN). The key pad 28 is placed in communication with the encryption module 30 and therefore the numbers of the PIN are received by the encryption module 30. It is noted that the communication of the PIN is direct and secure; the PIN cannot be intercepted between the key pad 28 and the encryption module 30. The PIN is then encrypted by the encryption module 30 to define a PIN block. The encryption module 30 includes a network encryption key and applies the network encryption key to encrypt the PIN to the PIN block. The exemplary encryption module 30 is configured to transmit the PIN block to the exemplary computing device 22, which can direct the PIN block away from the ATM 20 during the completion of a financial transaction.

The exemplary ATM 20 also includes a card reader (not referenced in the drawings, but a known component of ATMs). The card reader can receive a token from the user, such as a card. The card reader can be configured to execute read and write operations with respect to any storage medium fixed to the user's card. The exemplary card reader can be configured to read data from a magnetic strip on the back of a card or a chip embedded in the card. The exemplary card reader can be configured to transmit any data read from the user's card to the exemplary computing device 22, which can direct the data read from the card away from the ATM 20 during completion of a financial transaction. The exemplary card reader can also be configured to receive commands and data from the exemplary computing device 22 and change data stored on the user's card.

The exemplary ATM 20 also includes a printer module 36. The exemplary computing device 22 can control the printer module 36 to print a receipt when a transaction has been completed. The printer module 36 can communicate one or more messages to the exemplary computing device 22, such as a maintenance message regarding the need to refill printer paper.

The exemplary ATM 20 also includes an article exchange unit 38. In the exemplary embodiment, the article exchange unit 38 is configured to receive items such as checks. An exemplary article exchange unit 38 can include a drum on which received items are stored. The exemplary article exchange unit 38 includes a slot 40 open to an exterior of the ATM 20 for the receipt of such items. In other embodiments of the present disclosure, an article exchange unit can be configured to facilitate the receipt of other items, different than paper. The article exchange unit 38 can include one or more sensors and transmit signals from any such sensors to the exemplary computing device 22 to execute an exchange. The exemplary computing device 22 can control the article exchange unit 38 in response to such signals. For example, the article exchange unit 38 can include a sensor that detects receipt of an item such as a check. The article exchange unit 38 can include a further sensor in the form of a scanner that generates an image of the received item and transmits the image to the exemplary computing device 22. When an exchange involves the dispensation of an article to the user, the exemplary computing device 22 can control the article exchange unit 38 to dispense the item(s) requested by the user.

The exemplary ATM 20 also includes a printer module 42. The printer module 42 can generate a continuous record of all transactions executed by the ATM 20. The exemplary computing device 22 can control the printer module 42 to supplement the record after each transaction has been completed. The printer module 42 can communicate one or more messages to the exemplary computing device 22, such as a maintenance message regarding the need to refill printer paper.

The exemplary ATM 20 also includes an access module 44. The access module 44 can be positioned proximate to a rear side of the ATM 20. The access module 44 can be utilized by service and support technicians. For example, the access module 44 can be utilized by a field engineer to complete software updates to the exemplary computing device 22. The access module 44 can also be utilized when non-software updates and maintenance is performed, such as the refilling of printer paper or currency.

The exemplary ATM 20 also includes a transceiver 46. The exemplary transceiver 46 is configured to facilitate communication between the exemplary computing device 22 and other computing devices that are distinct from and physically remote from the exemplary computing device 22. An example of such a remote computing device is a server computing device, such as a banking or financial institution server communicating with a plurality of ATMs, such as the first server 12 referenced in FIG. 1. Referring again to FIG. 2, the exemplary transceiver 46 places the exemplary computing device 22 in communication with one or more networks, such as network 48. The network 48 can be a local area network (LAN), a wide area network (WAN) such as the Internet, a Multi-protocol label switching (MPLS) network, a cellular network such as operated by cellular phone companies, or any combination thereof. The network 48 can be a financial switching/bank network such as NYCE, PULSE, PLUS, Cirrus, AFFN, Interac, Interswitch, STAR, LINK, MegaLink, or BancNet. The transceiver 46 can transmit data and requests for input generated by the exemplary computing device 22 and receive responses to these requests, directing these responses to the exemplary computing device 22.

The exemplary ATM 20 also includes a transceiver 50. The exemplary transceiver 50 is configured to facilitate communication between at least one of the encryption module 30 and the exemplary computing device 22 and other computing devices that are distinct from and physically proximate to the ATM 20. An example of such a proximate computing device is a smartphone possessed by the user. The dashed connection lines in FIG. 2 represent optional interconnections. The exemplary transceiver 50 can place the user's smartphone in communication with the encryption module 30, the exemplary computing device 22, or both. The exemplary transceiver 50 can implement various communication protocols. For example, the transceiver 50 can be a Near Field Communication (NFC) device. Alternatively, the transceiver 50 can be a Bluetooth beacon. The transceiver 50 can transmit and receive data and requests for input generated by the encryption module 30 and/or the exemplary computing device 22, such transmissions occurring with the user's smart phone for example.

The exemplary ATM 20 also includes a recycler 52. The exemplary recycler 52 can dispense and receive banknotes, such as currency. The exemplary recycler 52 is positioned in a safe 54. One or more cassettes or cash boxes 56 are also positioned and protected in the safe 54. Banknotes are stored in the cassettes 56 for disbursement to a user of the ATM 20. The exemplary recycler 52 can extract the banknotes from one or more of the cassettes 56 and direct them out of the ATM 20 through the slot 40. The exemplary recycler 52 can also direct banknotes received through the slot 40 to one of the cassettes 56. The exemplary recycler 52 thus communicates with the slot 40 in parallel with the article exchange unit 38. The exemplary recycler 52 can communicate with and be controlled by the exemplary computing device 22 for at least some operations. Each of the cassettes 56 can engage the exemplary recycler 52 through a rack whereby the positioning of the cassettes is controlled. Further, the each of the cassettes 56 and the exemplary recycler 52 can include mating connectors of any form, whereby a positive interconnection is confirmed electronically. When one or more of the cassettes 56 and the exemplary recycler 52 are not properly interconnected, a signal or lack thereof can be communicated to the exemplary computing device 22 whereby an error message is generated or the ATM 20 can be disabled.

The exemplary ATM 20 also includes a scanner 58. The scanner 58 can scan, for example, at least a portion of a display of a smart phone and communicate the scanned display to the exemplary computing device 22. A token can be displayed on the display of the smart phone and thus scanned by the scanner 58. The token can be a bar code, a quick response (QR) code, a number, a string of alphanumeric characters, a weblink, or some other symbolic indicia. The exemplary scanner 58 is configured to transmit any scanned data to the exemplary computing device 22, which can direct the scanned away from the ATM 20 during completion of a financial transaction.

Referring again to FIG. 1, the exemplary financial transaction system 10 also includes a second ATM 60 positioned in the building 16 at the first location. The exemplary second ATM 60 includes a recycler and at least one cassette configured to hold currency. The exemplary second ATM 60 lacks a display and a card reader. This form of ATM is sometimes referred to as a “headless ATM.” The exemplary second ATM 60 is disposed in communication with the second server 14 over a local secure network. The box in dash-line can be viewed as referencing the physical building of the branch 16 as well as the local secure network operating within the branch 16.

The exemplary financial transaction system 10 also includes a tablet computing device 62 having one or more processors. The exemplary tablet computing device 62 is moveably located in the building 16 at the first location. The exemplary tablet computing device 62 is in communication with the second server 14 over the local secure network. The exemplary tablet computing device 62 can load operating programs from the second server 14 so that changes to such programs can be more easily propagated. The exemplary tablet computing device 62 is also configured to communicate directly with the second ATM 60, as will be discussed below. The exemplary tablet computing device 62 can be carried around the building 16 and operated by a bank employee, such as a bank teller, to assist bank customers as required.

The exemplary financial transaction system 10 also includes a desktop computing device 64 fixedly located in the building 16 at the first location. The exemplary desktop computing device 64 is in communication with the second server 14 over the local secure network. The exemplary desktop computing device 64 can load operating programs from the second server 14 so that changes to such programs can be more easily propagated. The exemplary desktop computing device 64 can be operated by a bank teller fixed at a teller workstation.

The exemplary financial transaction system 10 also includes at least one peripheral in communication with the second server 14 over the local secure network. In FIG. 1, the at least one peripheral is illustrated as a printer 66. However, a peripheral of the system 10 can be defined by an electronic signature pad, a card reader, a display, or any other component utilized in the branch 16.

The exemplary financial transaction system 10 provides objective benefits to banks. In particular, aspects of the system 10 reduce the frequency that cash deliveries must be made to a bank branch while also allowing cash vaults to be downsized. Further, the system 10 can minimize the extent of physical contact between currency and bank employees, which inhibits the transfer of viruses. For example, in one exemplary operation associated with the system 10, a customer can enter the branch 16. The customer can be greeted before the customer enters a line to interact with a teller operating the fixed desktop computing device 64. The customer can be engaged by a teller carrying the tablet computing device 62. The teller carrying the tablet computing device 62 can receive data from the customer detailing a desired financial transaction. By way of example and not limitation, the desired financial transaction can be a cash withdrawal.

The teller carrying the tablet computing device 62 can enter the data received from the customer in the tablet computing device 62. The data can be transmitted to the second server 14 which further transmits the data to the first server 12 for assessment, leading to denial or approval of the desired transaction. The data sent to the first server 12 can be designated as a first input and the tablet computing device 62 can be designated as a tertiary computing device. Thus, the first server 12 receives a first input from a tertiary computing device that is positioned in the building 16 at the first location with the second ATM 60, wherein the tertiary computing device is physically distinct from the second ATM 60 and the first input defines details of a financial transaction.

If the transaction is approved, the first server 12 transmits a first output that includes approval of the financial transaction. The first output can be transmitted to the second ATM 60 or the tablet computing device 62. If the second ATM 60 receives the first output from the first server 12, the first server 12 can also transmit a dispense command to the second ATM 60 and transmit a notification of approval to the tablet computing device 62. If the first server 12 transmits the first output to the tablet computing device 62, the tablet computing device 62 can generate a dispense command and transmit the dispense command to the second ATM 60. The dispense command can be transmitted directly from the tablet computing device 62 to the second ATM 60 or indirectly through the second server 14. In one or more embodiments of the present disclosure, the first output can be transmitted from the first server 12 to a mobile computing device of a user. In FIG. 1, an exemplary mobile computing device is referenced at 68. The first output could take the form of a QR code, barcode, or a numerical value, or could take some other form. The user can input the first output to the ATM 60 or could allow the exemplary mobile computing 68 to communicate directly with the ATM 60.

The second ATM 60 can thus receive a command to dispense currency from the first server 12 or the tablet computing device 62. In response to receiving the command to dispense, a recycler of the second ATM 60 dispenses a quantity of currency to the customer. Neither the teller operating the tablet computing device 62 nor the customer need touch the second ATM 60 to complete the transaction.

In a second exemplary operation associated with the system 10, a customer can pre-stage a transaction on the customer's mobile computing device 68. An application, or “app,” such as a banking app, can be operating on the mobile computing device 68 and the app can be at least partially controlled by the first server 12. The pre-staged transaction defines the first input in the second exemplary operation associated with the system 10. Thus, in the second exemplary operation associated with the system 10, the first input is generated with the application operating on the mobile computing device 68 and the mobile computing device 68 defines the tertiary computing device. By way of example and not limitation, the desired financial transaction in the second exemplary operation can be a cash deposit. It is noted that any transaction described herein as “pre-staged” is so described for exemplary purposes and is not limiting. Any transaction described herein as “pre-staged” could be completed by the system 10 when not pre-staged.

After the pre-staged transaction is created, the customer can enter the branch 16 and proceed directly to the second ATM 60. The customer can present the display of the mobile computing device 68 to a scanner of the ATM 60, such as scanner 58 of the ATM 20. The application operating on the mobile computing device 68 can control the display of the mobile computing device 68 to display a token, such as QR code. The displayed QR code can be scanned by the scanner and the data defined by the QR code can be transmitted to the second server 14 which further transmits the data to the first server 12 for confirmation that the data of the QR code corresponds to the pre-staged transaction. The data sent to the first server 12 during the pre-staging can be designated as a first input in this second exemplary operation.

If the QR code corresponds to the pre-staged transaction, the first server 12 transmits the first output that includes approval of the financial transaction to the ATM 60 and also transmits a command to intake currency from the customer. In response to receiving the intake command, a recycler of the ATM 60 intakes a quantity of currency to the customer. Neither a teller nor the customer need touch the ATM 60 to complete the transaction.

It is noted that in another exemplary operation, the tablet computing device 62 can be utilized to control the ATM 60 to intake at least one note of currency, in the sense that the tablet computing device 62 can send a command to the ATM 60 and the ATM 60 will execute the command. The tablet computing device 62 can include a camera or scanner to scan the token displayed on the mobile computing device 68. The scan of the token can be transmitted to the second server 14 which further transmits the data to the first server 12 for confirmation that the data of the QR code corresponds to the pre-staged transaction. If the QR code corresponds to the pre-staged transaction, the first server 12 transmits the first output that includes approval of the financial transaction to the tablet computing device 62 and also transmits a command to intake currency from the customer. In response to receiving the intake command, the tablet computing device 62 transmits the intake command to the ATM 60 and a recycler of the ATM 60 intakes a quantity of currency to the customer. Neither a teller nor the customer need touch the ATM 60 to complete the transaction. It is noted that in one or more embodiments of the present disclosure, the QR code could also correspond to a particular terminal identification of the ATM 60.

In a third exemplary operation associated with the system 10, a customer can enter the branch 16. The customer can enter a line to interact with a teller operating the fixed desktop computing device 64. The teller operating the fixed desktop computing device 64 can receive data from the customer detailing a desired financial transaction. By way of example and not limitation, the desired financial transaction can be partial deposit and partial cashing of a check.

The teller operating the fixed desktop computing device 64 can assess the desired financial transaction. The transaction details can be transmitted, as the first input, to the first server 12 for approval. If the transaction is approved, the first server 12 transmits a first output that includes approval of the financial transaction to the desktop computing device 64.

The second ATM 60 can be located proximate to the fixed desktop computing device 64. For example, the fixed desktop computing device 64 can be located behind a counter and the second ATM 60 can be positioned below the counter, facing away from the fixed desktop computing device 64. The customer can thus access the second ATM 60 while interacting with the teller who is operating the fixed desktop computing device 64.

After the transaction is approved, the teller can control the desktop computing device 64 to send a command to the second ATM 60 that is executed by the ATM 60. The desktop computing device 64 transmit commands to the second ATM 60. The commands can include an intake command to intake the check from the customer and a dispense command to dispense currency to the customer. Neither the teller operating the desktop computing device 64 nor the customer need touch the second ATM 60 to complete the transaction. In one or more embodiments of the present disclosure, the teller can control the desktop computing device 64 to transmit a token to the user's mobile computing device 68 after the transaction is approved. The user can then proceed to the ATM 60 and present the token to complete the transaction. The token could take the form of a QR code.

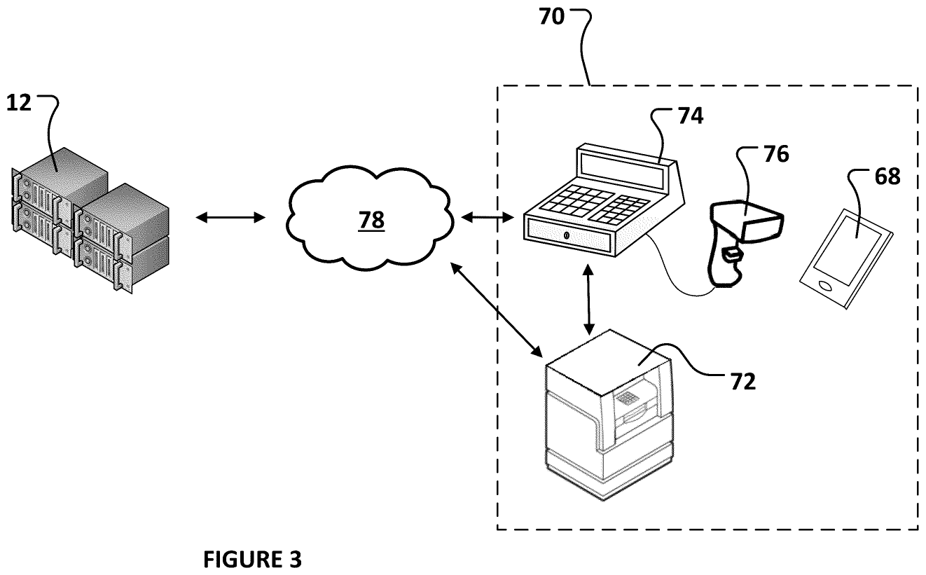

In another aspect of the present disclosure, the exemplary financial transaction system 10 can also be utilized in locations other than bank branches. FIG. 3 is a schematic view of further aspects of the exemplary financial transaction system. The first server 12 is shown communicating with components positioned within a building of a merchant. The box in dash-line referenced by 70 represents a building of a merchant, which is physically remote from the exemplary first server 12. A third ATM 72 is located in the building 70. The third ATM 72 is constructed similarly to the second ATM 60, a headless ATM. FIG. 3 also shows a secondary computing device 74 and a scanner 76 positioned in the building 70 as well as a customer's mobile computing device 68. The exemplary secondary computing device 74 is point of sale (POS) device. The secondary computing device 74 and the ATM 72 are configured to communicate with one another.

The exemplary POS device 74 is disposed in communication with the exemplary first server 12 over a network 78. The network 78 can be a local area network (LAN), a wide area network (WAN) such as the Internet, a Multi-protocol label switching (MPLS) network, a cellular network such as operated by cellular phone companies, or any combination thereof. The exemplary POS device 74 can transmit transaction requests to the exemplary first server 12 over the exemplary network 78. The exemplary POS device 74 can receive approvals or denials of transaction requests from the exemplary first server 12 over the exemplary network 78.

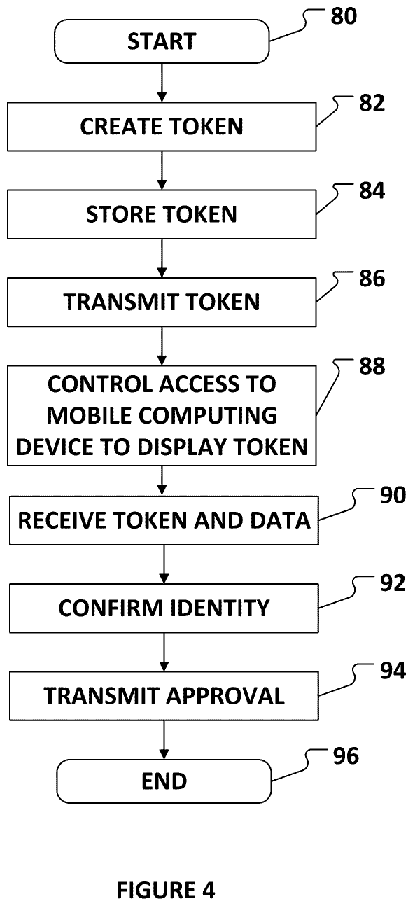

FIG. 4 is a simplified flow diagram of an exemplary process that can be carried out by the components shown in FIG. 3. The process starts at 80. At 82, the first server 12 creates a token correlated to a financial account. The creation of the token can occur in response to a request from the holder of a financial account (hereafter the “customer”) to pre-stage or execute a financial transaction. The customer may be located at the building 70 when the pre-staging request is received by the first server 12 or the pre-staging request may be received by the first server 12 before the customer arrives at the building 70.

The request to create the token can be communicated from the banking app running on the mobile computing device 68. In one or more embodiments, the banking app can allow the customer to input an amount of expected purchase or a range of purchase prices or a maximum amount. The app can transmit the amount input by the customer with the request for the creation of a token. The exemplary first server 12 operates a token database. At 84, the correlation between the token and the financial account is stored in the token database by the first server 12.

At 86, the first server 12 transmits the token to the mobile computing device 68. The exemplary mobile computing device 68 is operating the application that is at least partially controlled by the first server 12. For example, the first server 12 at least partially controls the app, which is at least partially the mobile computing device 68, since the information displayed on the mobile computing device 68 when the app is operating is provided/directed by the first server 12. Thus, at 88, the token is displayed on a display of the mobile computing device 68 with the application operating on the mobile computing device 68. The token can take the form of a QR code.

At 90, the first server 12 can receive back the token and data associated with a first financial transaction after sending the token to the mobile computing device 68. In one or more embodiments of the present disclosure, the data can include a transaction amount such as a purchase price, an identification of the merchant, an identification of the building 70, and/or an identification of the good or service being purchased. The token and data can be received from the secondary computing device 74. The token and data can be received over the network 78 that is at least partially public. The exemplary network 78 is not a financial switching network or a point of sale network. The exemplary network 78 defined between the first server 12 and the secondary computing device 74, along which the token and data are transmitted, does not include portions of the financial switching/bank networks in the exemplary embodiment. The transmission can occur after the scanner 76 has scanned the token displayed on the display of the mobile computing device 68 and has thus captured the token. The secondary computing device 74 and the scanner 76 are connected with one another and the secondary computing device 74 receives the token from the scanner 76.

At 92, the first server 12 can confirm identity between the token transmitted to the mobile computing device 68 and the token received from the secondary computing device 74. At 94, the first server 12 can transmit, over the network 78, approval of the financial transaction to the secondary computing device 74 in response to confirming identity. The process ends at 96.

The method described above defines technical improvements over the prior art. First, communicating the token from the secondary computing device 74 to the first server 12 over a non-financial network reduces costs and increases speed. Transmissions over the financial switching networks and point of sale networks are assessed a fee. Further, the extent of security protocols applied in any particular network directly corresponds to extent of delays in transmissions; the financial switching networks and point of sale networks impose time-consuming security protocols on transmissions that are not applied on public networks. Second, exchanging the token between the customer and the merchant by scanning a display allows phone manufacturers to be excluded from involvement in financial transactions. Currently, phone manufacturers extract a fee for storing a token in a secure memory location and then providing the token during a transaction. By displaying the token on the display of a mobile device, the phone manufacturers provide nothing upon which to base a fee. Accomplishing a result at lower cost and faster speed indicates a technical improvement.

In one or more embodiments of the present disclosure, the first server 12 can receive the token and data from the third ATM 72. Thus, the third ATM 72 could define the secondary computing device instead of merchant's POS device 74. In one operation, the merchant's scanner 68 can communicate the token to the third ATM 72, the third ATM 72 can communicate the token for approval to the bank server 12, and the third ATM 72 can then communicate approval to the merchant's POS device 74. In another operation, the merchant's POS device 74 can communicate the token to the third ATM 72, the third ATM 72 can communicate the token for approval to the bank server 12, and the third ATM 72 can then communicate approval to the merchant's POS device 74. In yet another operation, the third ATM 72 can scan the token, communicate the token for approval to the bank server 12, and then communicate approval to the merchant's POS device 74. In these possible embodiments, direct communication between the merchant's POS device 74 and the first server 12 is eliminated which can simplify communications.

In one or more embodiments of the present disclosure, the first server 12 can determine an identification of a merchant at which the mobile computing device 68 is located prior to creating the token. The token can then be created by the first server 12 to be correlated to the financial account of the customer and also correlated to the merchant (to the identification of the merchant). In such embodiments, the token returned to and assessed by the first server 12 for approval would include the identification of the merchant. Further, the source of the communication that includes the token would be known to the first server 12. Thus, the first server 12 could confirm the data contained within the token regarding the identification of the merchant against the source of the communication that included the token. Identity between the tokens, the token stored in the database and the token received for approval, and identity between the identification of the merchant would further enhance security without burdening the pathway of communication.

The determination of the identification of the merchant can occur in one or more ways. In one approach, the first server 12 can receive a global position of the mobile computing device 68 operating the application substantially concurrently with receiving the token and the data associated with the first financial transaction from the secondary computing device. Substantially concurrently means generally at the same time, within a few seconds of one another for example. In these embodiments, the token may or may not be created with the identification of the merchant. The source of the token sent over the network 78 would be known to the first server 12 and the first server 12 can also receive location data from the application operating on the mobile computing device 68 for comparison. The first server 12 can have access to a database or service storing correlations between global positions and identifications of a merchants and access such a database/service to confirm the source of the token sent over the network 78 and the location of the mobile computing device 68 are the same.

In one or more embodiments of the present disclosure, determination of the identification of the merchant can occur after the customer arrives at the building 70 of the merchant. The customer can pre-stage the transaction after arriving at the building 70 of the merchant. The first server 12 can receive a global position of the mobile computing device 68 operating from application operating on the mobile computing device 68 substantially concurrently with a request for a pre-staged transaction. The first server 12 can have access to a database or service storing correlations between global positions and identifications of a merchants and access such a database/service to identify the merchant. The token can be created to complete the pre-staged transaction and can include the identification of the merchant.

In one or more embodiments of the present disclosure, the determination of the identification of the merchant can occur before the customer arrives at the building 70 of the merchant. For example, the application operating the mobile computing device 68 can have access to a database or service storing correlations between global positions and identifications of a merchants and access such a database/service to identify merchants. The application can control the display of the mobile computing device 68 to display indicia corresponding to one or more identifications of merchants in response to a customer input. The customer can select a particular merchant from the display. The first server 12 can receive the identification of the merchant, chosen by the customer, from the application operating on the mobile computing device 68 before the token is created. The token can then be created to include the identification of the merchant.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein is hereby unconditionally reserved. The use of the word “can” in this document is not an assertion that the subject preceding the word is unimportant or unnecessary or “not critical” relative to anything else in this document. The word “can” is used herein in a positive and affirming sense and no other motive should be presumed. More than one “invention” may be disclosed in the present disclosure; an “invention” is defined by the content of a patent claim and not by the content of a detailed description of an embodiment of an invention.

What is claimed is:

1. A financial transaction method comprising:
creating, with a first server operating a token database, a token correlated to a financial account;
storing, with the first server, the correlation between the token and the financial account in the token database;
transmitting, with the first server, the token to a mobile computing device operating an application at least partially controlled by the first server;
displaying the token on a display of the mobile computing device with the application operating on the mobile computing device;
receiving, at the first server, over a public network, the token and data associated with a first financial transaction from a secondary computing device after said transmitting;
confirming, with the first server, identity between the token transmitted to the mobile computing device and the token received from the secondary computing device; and
transmitting, with the first server, over the public network, approval of the first financial transaction to the secondary computing device in response to said confirming.

2. The method of claim 1 wherein said receiving is further defined as:
receiving, at the first server, over the public network, the token and data associated with the first financial transaction from the secondary computing device after said transmitting, wherein the secondary computing device is an automated transaction machine (ATM).

3. The method of claim 1 wherein said receiving is further defined as:
receiving, at the first server, over the public network, the token and data associated with the first financial transaction from the secondary computing device after said transmitting, wherein the secondary computing device is a point of sale (POS) device.

4. The method of claim 1 further comprising:
determining, with the first server, an identification of a merchant at which the mobile computing device is located prior to said creating.

5. The method of claim 4 wherein:
said creating is further defined as creating, with the first server operating the token database, the token correlated to the financial account and correlated to the identification of the merchant;
said receiving is further defined as receiving, at the first server, over the public network, the token and the data associated with the first financial transaction and the identification of the merchant from the secondary computing device after said transmitting; and
said confirming is further defined as confirming, with the first server, identity between the token transmitted to the mobile computing device and the token received from the secondary computing device and also identity between the identification of the merchant determined during said determining and the identification of the merchant received during said receiving.

6. The method of claim 4 wherein said determining step further comprises:
receiving, with the first server, a global position of the mobile computing device operating the application substantially concurrently with said receiving the token and data associated with the first financial transaction from the secondary computing device; and
accessing, with the first server, a database storing correlations between global positions and identifications of a merchants.

7. The method of claim 6 wherein said determining step further comprises:
transmitting, with the application operating on the mobile computing device, the global position of the mobile computing device to the first server.

8. The method of claim 4 wherein said determining step further comprises:
receiving, with the first server, a global position of the mobile computing device operating the application before said receiving the token and data associated with the first financial transaction from the secondary computing device; and
accessing, with the first server, a database storing correlations between global positions and identifications of a merchants before said receiving the token and data associated with the first financial transaction from the secondary computing device.

9. The method of claim 4 wherein said determining step further comprises:
receiving, with the first server, the identification of the merchant from the application operating on the mobile computing device before said receiving the token and data associated with the first financial transaction from the secondary computing device.

10. The method of claim 9 further comprising:
controlling, with the application operating on the mobile computing device, a display of the mobile computing device to display indicia corresponding to one or more identifications of merchants, wherein the identification of the merchant received during said receiving the identification of the merchant with the first server, is one of the identifications displayed during said controlling.

11. The method of claim 1 further comprises:
positioning an automated transaction machine (ATM) in a building at a first location, wherein the ATM includes a recycler and one or more cassettes configured to hold currency, and wherein the ATM lacks a display and a card reader;
placing the ATM in communication with the first server; and
positioning the first server at a second location that is physically remote from the building at the first location;
receiving, at the first server, a first input from a tertiary computing device that is positioned in the building at the first location with the ATM, wherein the tertiary computing device is physically distinct from the ATM, the first input defining details of a second financial transaction;
transmitting, with the first server, a first output to one of the ATM and the tertiary computing device, the first output including approval of the second financial transaction;
receiving, at the ATM, a command to dispense currency from one of the first server and the tertiary computing device; and
dispensing, with the recycler of the ATM, a quantity of currency in response to said receiving.

12. The method of claim 11 wherein:
said transmitting the first output is further defined as transmitting, with the first server, the first output to the tertiary computing device, the first output including approval of the second financial transaction; and
said receiving the command is further defined as receiving, at the ATM, the command to dispense currency from the tertiary computing device.

13. The method of claim 11 wherein:
said transmitting the first output is further defined as transmitting, with the first server, the first output to both of the ATM and the tertiary computing device, the first output including approval of the second financial transaction; and
said receiving the command is further defined as receiving, at the ATM, the command to dispense currency from the first server.

14. The method of claim 11 further comprising:
generating the first input with a tablet computer configured to at least partially control the ATM by the tablet computer sending commands that the ATM will execute, the tablet computer defining the tertiary computing device.

15. The method of claim 11 further comprising:
generating the first input with the application operating on the mobile computing device, the mobile computing device defining the tertiary computing device.

16. The method of claim 11 further comprising:
generating the first input with a desktop computing device configured to at least partially control the ATM, the desktop computing device defining the tertiary computing device.

17. The method of claim 11 further comprising:
controlling the ATM with the tertiary computing device to intake at least one note of currency by the tertiary computing device sending a command to the ATM to intake the at least one note of currency and the ATM executing the command.

18. The method of claim 11 further comprising:
controlling the ATM with the tertiary computing device to intake a check by the tertiary computing device sending a command to the ATM to intake the check and the ATM executing the command.

19. The method of claim 11 further comprising:
controlling the ATM with the tertiary computing device to intake a check and to dispense at least one note of currency by the tertiary computing device sending a command to the ATM to intake the check and to dispense at least one note of currency and the ATM executing the command.

20. A financial transaction system comprising:
a first server defining a financial core and maintaining a ledger of a plurality of financial accounts and transactions associated with the plurality of accounts;
a second server defining a branch server and disposed in communication with said first server over a first network, said second server positioned in a building at a first location while said first server is positioned at a second location that is physically remote from the building at the first location;
a first automated transaction machine (ATM) positioned at the building at the first location, said first ATM having a recycler, at least one cassette configured to hold currency, a display, a card reader, and an electronic pin pad (EPP), said first ATM in communication with said first server over a financial switch network;
a second ATM positioned in the building at the first location, wherein the second ATM includes a recycler, at least one cassette configured to hold currency, and wherein the second ATM lacks a display and a card reader, said second ATM in communication with said second server over a local secure network;
a tablet computing device having one or more processors and moveably located in the building at the first location, said tablet computing device in communication with said second server over the local secure network and configured to communicate directly with said second ATM;
a desktop computing device fixedly located in the building at the first location, said desktop computing device in communication with said second server over the local secure network; and
at least one peripheral in communication with said second server over the local secure network, said at least one peripheral selected from the group consisting of a printer, an electronic signature pad, and a card reader.
